(19) United States
(12) Patent Application Publication
(10) Pub. No.: US 2025/0301073 A1
(43) Pub. Date: Sep. 25, 2025

(54) PRINTER, PRINTING SYSTEM, NON-TRANSITORY COMPUTER READABLE MEDIUM AND METHOD

(71) Applicant: FUJIFILM Business Innovation Corp., Tokyo (JP)

(72) Inventor: Akiko MOCHIZUKI, Kanagawa (JP)

(73) Assignee: FUJIFILM Business Innovation Corp., Tokyo (JP)

(21) Appl. No.: 18/771,357

(22) Filed: Jul. 12, 2024

(30) Foreign Application Priority Data
Mar. 25, 2024 (JP) 2024-048641

(51) Int. Cl. H04N 1/00

(52) U.S. Cl. CPC H04N 1/00344; H04N 1/00079

(57) ABSTRACT

A printer includes a processor configured to: receive a replacement instruction of printers used in a cloud print service; in response to the reception of the replacement instruction, search for, via a network, each of the printers used in the cloud print service as a candidate of a printer to be replaced; receive a designation of the printer to be replaced by presenting, to a user, identification information on the candidates of the printers to be replaced; acquire, via the network and from the printer to be replaced, printer-to-be-replaced connection information used to connect to a cloud print server; and transmit to the cloud print server a replacement request used to replace the printer to be replaced with the printer by connecting to the cloud print server via the network using the printer-to-be-replaced connection information.

### CROSS-REFERENCE TO RELATED APPLICATIONS

This application is based on and claims priority under 35 USC 119 from Japanese Patent Application No. 2024-048641 filed March 25, 2024.

### Background

### (i) TECHNICAL FIELD

The present disclosure relates to a printer, a printing system, a non-transitory computer readable medium and a method.

### (ii) Related Art

Cloud print services have been recently available. In a printing system of the cloud print service, an administrator first registers a printer in the cloud print service. The administrator then makes the settings that allow a user to use the printer.

The user allowed to use the printer inputs a print job from a client terminal to the cloud print service. The cloud print service stores the received print job on a memory. The printer acquires the print job from the cloud print service and then performs printing. Japanese Unexamined Patent Application Publication Nos. 2020-194364 and 2012-88838 disclose operations related to the cloud print service.

When the printer registered in the cloud print service malfunctions and is replaced with a new printer, the registered printer is to be deleted from the service and then the new printer is to be registered.

### SUMMARY

Aspects of non-limiting embodiments of the present disclosure relate to facilitating a replacement operation of printers in a cloud print service in comparison with the case in which a user, such as an administrator, deletes a registered printer from the cloud print service and registers a printer as a replacement.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a printer including: a processor configured to: receive a replacement instruction of printers used in a cloud print service; in response to the reception of the replacement instruction, search for, via a network, each of the printers used in the cloud print service as a candidate of a printer to be replaced; receive a designation of the printer to be replaced by presenting, to a user, identification information on the candidates of the printers to be replaced; acquire, via the network and from the printer to be replaced, printer-to-be-replaced connection information used to connect to a cloud print server; and transmit to the cloud print server a replacement request used to replace the printer to be replaced with the printer by connecting to the cloud print server via the network using the printer-to-be-replaced connection information.

### BRIEF DESCRIPTION OF THE DRAWINGS

Exemplary embodiment of the present disclosure will be described in detail based on the following figures, wherein:

FIG. 1 illustrates an example of a configuration of a printing system;

FIG. 2 illustrates a flow of a replacement operation of printers;

FIG. 3 illustrates an example of a selection screen;

FIG. 4 illustrates an example of a list screen;

FIG. 5 illustrates an example of management information of a cloud server;

FIG. 6 illustrates an example of a completion screen; and

FIG. 7 illustrates an example of a hardware configuration of a computer.

### DETAILED DESCRIPTION

Exemplary embodiment of the disclosure is described in detail below with reference to the attached drawings. The configuration below is described for exemplary purposes only and may be appropriately modified. If the disclosure includes multiple exemplary embodiments and modifications thereof, features of the exemplary embodiments and modification may be combined. In the drawings, same or similar elements are designated with the same reference numerals and the discussion thereof is not duplicated.

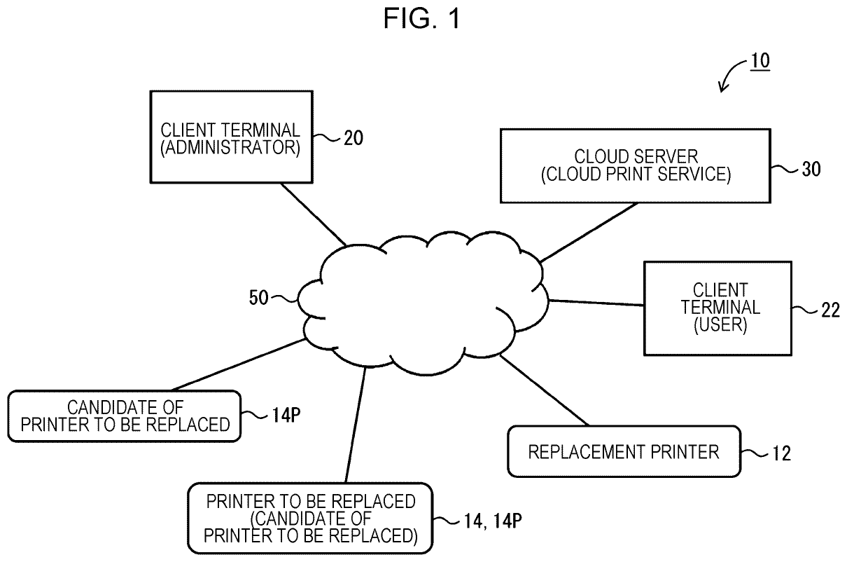

FIG. 1 illustrates an example of a configuration of a printing system 10. The printing system 10 includes multiple printers 12 and 14P, multiple client terminals 20 and 22, and a cloud server 30. The elements in the printing system 10 are interconnected to each other via a network 50. The numbers of the printers 12 and 14P, client terminals 20 and 22 and cloud server 30 are not limited to any particular number.

The printers 12 and 14P and client terminals 20 and 22 may be interconnected to each other via an in-house network of a company (such as local-area network (LAN)). The cloud server 30 may be connected to the printers 12 and 14P and client terminals 20 and 22 via the LAN and Internet.

According to the exemplary embodiment, the printer 14 (a printer to be replaced) currently registered is replaced with a new printer 12 (a replacement printer). The printer 14 to be replaced is designated from among the printers 14P serving as candidates of printers to be replaced.

The printers 12 and 14P perform printing on paper sheets in response to print data. The printers 12 and 14P may have another function in addition to a printing function. For example, the printers 12 and 14P may be a multi-function apparatus having a scan function, copy function, fax function and e-mail transmission and reception function. The printers 12 and 14P may include a finisher that performs a scoring operation, folding operation, stapling operation, cutting operation and other operations.

The client terminal 20 is a computer, such as a personal computer (PC), operated by an administrator. The client terminal 22 is a computer, such as a PC, operated by a user. The users may include both an administrator and a general user.

Each of the printers 12 and 14P includes a web user interface (WUI). The client terminals 20 and 22 use a web browser to operate the printers 12 and 14P and view the screens of the printers 12 and 14P. According to the exemplary embodiment, the administrator uses the client terminal 20 to remotely operate the printer 12 via WUI. The screen or notice provided to the administrator by the printer 12 is displayed on a display of the client terminal 20.

The administrator may operate the printer 12 using a local user interface (LUI), such as a touch panel, arranged on the printer 12. The screen or notice provided to the administrator may be displayed on the display (such as a touch panel) of the printer 12.

The cloud server 30 includes one or more computers. The cloud server 30 provides a cloud print service. The cloud server 30 may also be referred to as a cloud print server. The cloud print service includes registration of a printer and a user, authentication of the user, and a printing operation performed by the registered user. The cloud print service includes, for example, Universal Print (registered trademark) provided by Microsoft (registered trademark).

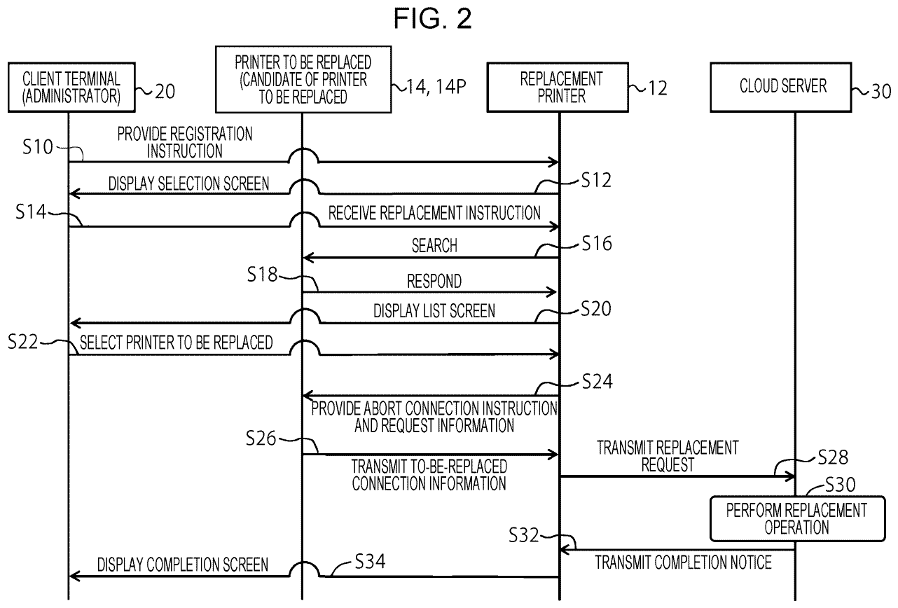

FIG. 2 illustrates a flow of a replacement operation of printers. The administrator first performs settings on the printer 12 as a new printer serving as a replacement and thus connects the printer 12 to the network 50. In step S10, the administrator provides a registration instruction to the printer 12 using the client terminal 20.

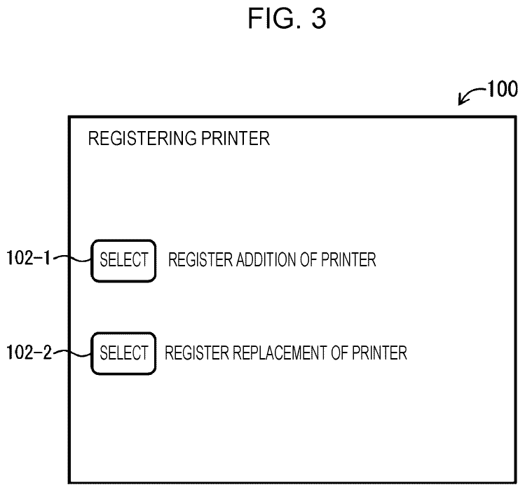

In response to the reception of the registration instruction, the printer 12 as the replacement provides the administrator with a selection screen 100 in step S12. FIG. 3 illustrates an example of the selection screen 100. The selection screen 100 includes buttons 102-1 and 102-2 that are used to alternatively select between “registering addition of printer” and “registering replacement of printer.” The administrator selects between “registering addition of printer” and “registering replacement of printer” on the selection screen 100.

If the administrator selects “registering addition of printer” by pressing the button 102-1, a registration operation of a printer is performed in the cloud print service of related art. On the other hand, if the administrator selects “registering replacement of printer” by pressing the button 102-2, a replacement operation of printers is performed as described below. When the button 102-2 is pressed, the client terminal 20 transmits a replacement instruction to the printer 12 as a replacement in step S14.

In response to the reception of the replacement instruction, the printer 12 searches in step S16 via the network 50 for each of the printers currently used in the cloud print service as a candidate of a printer 14P to be replaced. For example, the printer 12 as a replacement detects a printer in a subnet to which the printer 12 belongs, using a program (such as Bonjour) that automatically detects a device on an Internet protocol (IP) network. For example, the printer 12 as the replacement transmits a search signal to multiple printers in the subnet of the printer 12 and receives a response signal from each of these printers (step S18). The response signal includes information on whether the cloud print service is effective on the printer 12 that has transmitted the response signal. If the response signal indicates that the cloud print service is effective, the replacement printer 12 identifies the printer having transmitted the response signal to be the candidate of the printer 14P to be replaced.

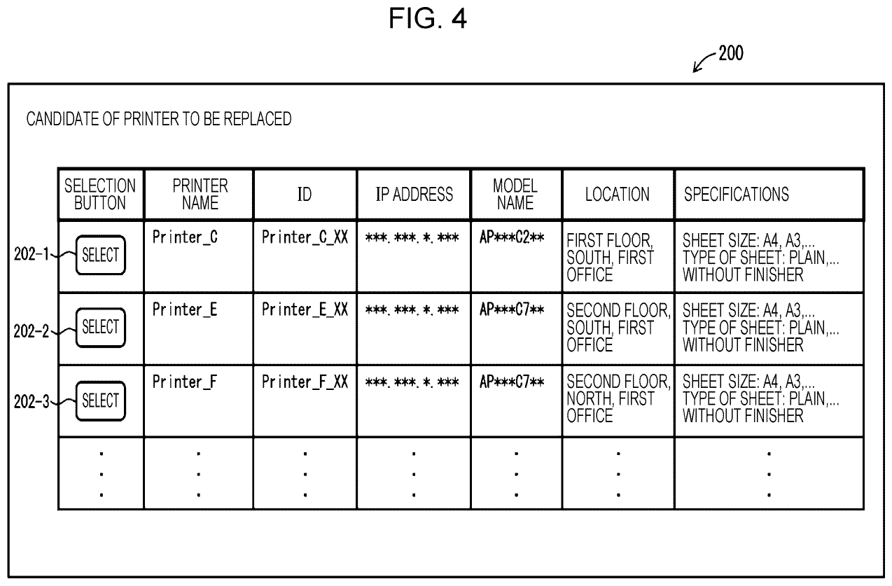

In step S20, the replacement printer 12 provides the administrator with a list screen 200 of the candidates of the printers 14P to be replaced. FIG. 4 illustrates an example of the list screen 200. The list screen 200 lists a printer name, identification (ID), Internet protocol (IP) address, model name, location and specifications of each of the candidates of the printers 14P to be replaced. The location signifies where each printer is installed. The specifications indicate print settings specifiable on the printer and is information related to a function of the printer and an optional unit of the printer. The printer name, ID and IP address are identification information on the printer. If the candidates of the printers 14P to be replaced are different in terms of the model name, location and specifications, the model name, location and specifications also serve as the identification information that is used to select a printer.

The list screen 200 includes buttons 202-1 through 202-3 that select the printers 14 to be replaced. On the list screen 200, the administrator specifies the printer 14 to be replaced by pressing a button (one of the buttons 202-1 through 202-3) corresponding to the printers 14 to be replaced (step S22).

In response to the reception of the designation of the printer 14 to be replaced, the replacement printer 12 transmits in step S24 to the printer 14 to be replaced an abort instruction that aborts connection to the cloud server 30. In the cloud print service, the printer periodically accesses the cloud server 30 and checks the cloud server 30 for the presence or absence of a print job. In response to the reception of the abort instruction from the replacement printer 12, the printer 14 to be replaced aborts accessing to the cloud server 30.

In step S24, the replacement printer 12 requests, from the printer 14 to be replaced, printer-to-be-replaced information used to connect to the cloud server 30. The printer-to-be-replaced information includes authentication information, such as a uniform resource locator (URL) assigned as an access destination by the cloud print service, ID used to log in on the cloud print service, and access token. In response to the request for the printer-to-be-replaced information, the printer 14 to be replaced transmits the printer-to-be-replaced information to the replacement printer 12 in step S26. The replacement printer 12 receives the printer-to-be-replaced information.

In step S28, the replacement printer 12 connects to the cloud server 30 via the network 50 in accordance with the printer-to-be-replaced information and transmits to the cloud server 30 a replacement request from the printer 14 to be replaced to the printer (the replacement printer 12).

The replacement request to the cloud server 30 may include authentication information on the administrator. In such a case, the replacement printer 12 may acquire the authentication information on the administrator from the client terminal 20 before transmitting the replacement request. The replacement request to the cloud server 30 may include information on the replacement printer 12 and information on the printer 14 to be replaced.

In response to the reception of the replacement request, the cloud server 30 performs a replacement operation in step S30 by deleting the registration of the printer 14 to be replaced and registering the replacement printer 12.

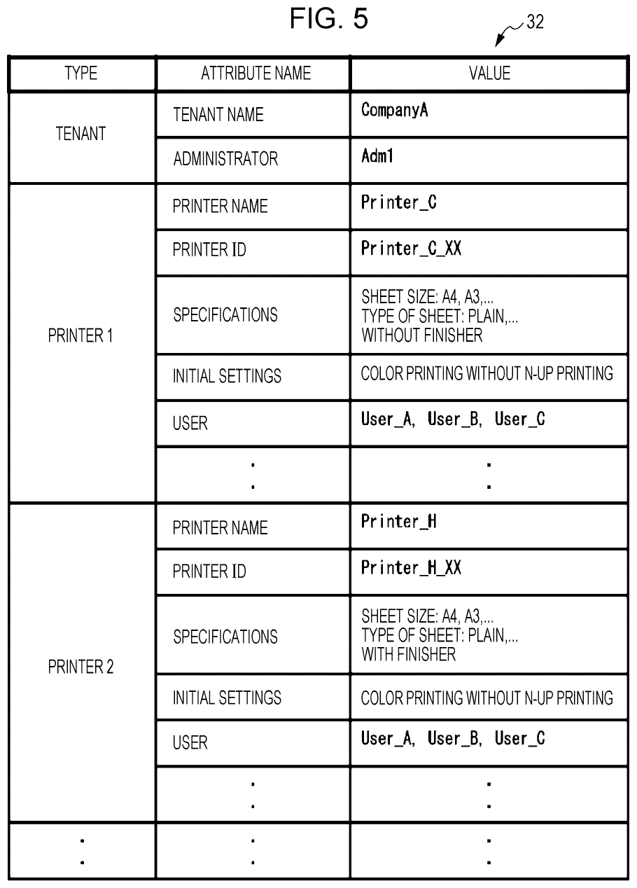

FIG. 5 illustrates an example of management information 32 on the cloud server 30. In the cloud print service, information on printers is managed on a per group basis with each group including tenants. FIG. 5 illustrates the management information 32 on a tenant having a tenant name “Company A.” Referring to FIG. 5, “printer 1” is the printer 14 to be replaced and “printer 2” is the replacement printer 12. FIG. 5 illustrates the management information 32 in which the printer 2 (the replacement printer 12) is registered in the replacement operation before the printer 1 (the printer 14 to be replaced) is deleted.

The printer name, printer ID, specifications, initial settings and user are set on a per printer basis in the management information 32. The printer ID uniquely identifies a printer. The specifications indicate print settings specifiable on the printer. The initial settings indicate print settings in a default state when the printer performs printing. The print settings may include a color mode (color printing or monochrome printing), print paper sheet size (A4, A3, . . . ), availability of duplex printing, the number of pages printed on one side of a paper sheet (without N-up printing (1 page), 2-up printing (2 pages) . . . ), supported page description language (PDL), availability of a stapler serving as an optional unit, and stapling locations. The user is a user who is granted to use the printer.

The cloud server 30 updates the management information 32 in the replacement operation. The cloud server 30 may set, onto the replacement printer 12, information on the printer 14 to be replaced. Specifically, the information set on the printer 14 to be replaced may be transferred to the replacement printer 12.

The cloud server 30 may set the “initial settings” on the printer 14 to be replaced as the “initial settings” on the replacement printer 12. FIG. 5 illustrates a setting example in which “color printing without N-up printing” as the information on the initial settings on the printer 1 are set as the initial settings on the printer 2.

The cloud server 30 may set information on the “user” on the printer 14 to be replaced to be the “user” on the replacement printer 12. FIG. 5 illustrates a setting example in which “User_A, User_B, and User_C” as the information on the user of the printer 1 are set to the user of the printer 2.

According to the exemplary embodiment, the printer 14 to be replaced and the replacement printer 12 are different in terms of printer name. Similarly, the printer 14 to be replaced and the replacement printer 12 are different in terms of printer ID. However, the printer name set on the printer 14 to be replaced may be transferred to the replacement printer 12. The printer ID set on the printer 14 to be replaced may be transferred to the replacement printer 12.

The cloud server 30 manages the authentication information on a per printer basis although this operation is not illustrated. The authentication information on the printer 14 to be replaced may be transferred to the replacement printer 12. The cloud server 30 may manage the administrator of each printer on a per printer basis. In such a case, the administrator of the printer 14 to be replaced may be transferred to the replacement printer 12.

The replacement operation may be performed in the following three methods.
(1) The information on the replacement printer 12 is recorded in the management information 32 after the information on the printer 14 to be replaced is deleted.
(2) The information on the printer 14 to be replaced is deleted in the management information 32 after the information on the replacement printer 12 is recorded.
(3) The information on the replacement printer 12 overwrites the information on the printer 14 to be replaced in the management information 32.

When the replacement operation is complete, the cloud server 30 transmits a completion notice to the replacement printer 12 in step S32 in FIG. 2. The completion notice indicates that the printer 14 to be replaced has been replaced with the replacement printer 12.

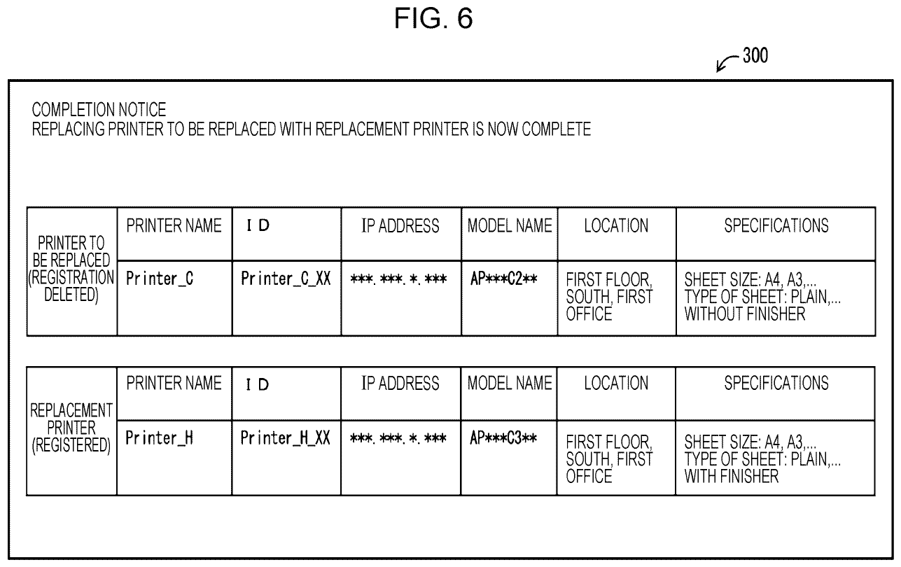

In response to the reception of the completion notice, the replacement printer 12 presents a completion screen 300 to the administrator in step S34. FIG. 6 illustrates an example of the completion screen 300. The completion screen 300 displays deletion information indicating that the registration of the printer 14 to be replaced has been deleted and registration information indicating that the registration of the replacement printer 12 has been completed.

As illustrated in FIG. 6, the deletion information may include the printer name, ID, IP address, model name, location and specifications of the printer 14 to be replaced. Similarly, the registration information may include the printer name, ID, IP address, model name, location and specifications of the replacement printer 12.

The completion screen 300 may be provided to a client terminal 22 of a general user other than the administrator.

When the completion notice is received from the cloud server 30, the replacement printer 12 may transmit the replacement request of printers to the client terminals 20 and 22 of the users. In response to the reception of the replacement request, the client terminals 20 and 22 may update information stored thereon such that the information on the printer 14 to be replaced is replaced with the information on the replacement printer 12.

In response to the reception of the completion notice from the cloud server 30, the replacement printer 12 may notify the printer 14 to be replaced that the replacement is complete. In response to the reception of the notice of replacement completion, the printer 14 to be replaced may modify the settings thereof or notify the client terminals 20 and 22 of the users of the notice of the replacement completion.

Since the registration deletion (registration canceling) of the printer and the registration of a new printer are performed at a time in the cloud print service according to the exemplary embodiment described above, the replacement operation of the printer by the administrator may be facilitated. The replacement operation may be easier than when the administrator performs the replacement operation by accessing the cloud print service.

If only printers used in the cloud print service and belonging to the same subnet as the replacement printer 12 are set to be the candidates of the printers 14P to be replaced, the number of printers presented to the administrator on the list screen 200 (see FIG. 4) may be reduced. The administrator may thus easily specify the printer 14 to be replaced.

If the information on the printer 14 to be replaced is transferred to the replacement printer 12 in the cloud server 30, time used to set the information onto the replacement printer 12 may be saved or reduced.

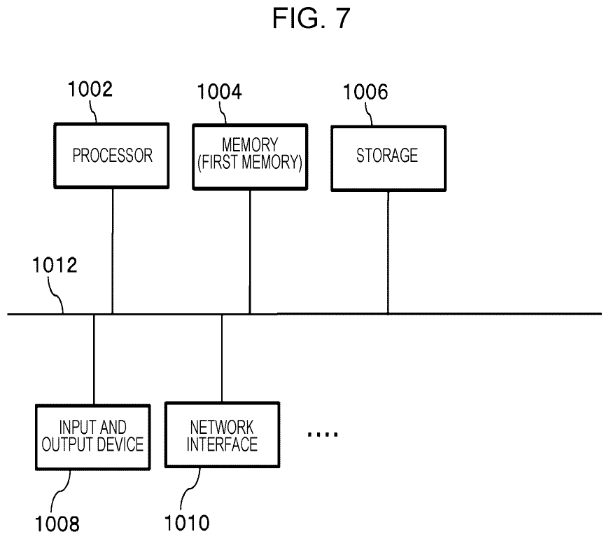

The printer described above, client terminal and cloud server may be a single computer or a system including multiple computers that operate in corporation with each other. Referring to FIG. 7, the computer of the printer, client terminal or cloud server may include a processor 1002, memory (first memory) 1004, storage 1006, input and output device 1008, network interface 1010, and the like. The memory 1004 may include a random-access memory (RAM). The storage 1006 may include a flash memory, solid-state drive (SDD) and/or hard-disk drive (HDD). The network interface 1010 controls connection with a network. Referring to FIG. 7, the elements of the computer may be connected to each other via a data transmission path, such as a bus 1012. A program as a written processing content may be installed on a computer via a network and stored on the storage 1006. When the processor 1002 performs the program on the storage 1006 using the memory 1004, the printers described above, client terminal and/or cloud server are configured.

The program may be provided via a network, such as the Internet or by storing the program on a computer-readable recording medium, such as an optical disk or a universal serial bus (USB) memory.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A printer including:

a processor configured to:
receive a replacement instruction of printers used in a cloud print service;
in response to the reception of the replacement instruction, search for, via a network, each of the printers used in the cloud print service as a candidate of a printer to be replaced;
receive a designation of the printer to be replaced by presenting, to a user, identification information on the candidates of the printers to be replaced;
acquire, via the network and from the printer to be replaced, printer-to-be-replaced connection information used to connect to a cloud print server; and
transmit to the cloud print server a replacement request used to replace the printer to be replaced with the printer by connecting to the cloud print server via the network using the printer-to-be-replaced connection information.
   (((2)))

In the printer according to (((1))), the processor is configured to:

present a selection screen that selectively receives the replacement instruction or an addition instruction of the printers used in the cloud print service; and

in response to the reception of the replacement instruction of the printers on the selection screen, perform a series of operations from searching for the candidates of the printers to be replaced to transmitting the replacement request.

(((3)))

In the printer according to one of (((1))) and (((2))), the processor is configured to:

receive from the cloud print server a completion notice indicating that replacing the printer to be replaced with the printer is complete; and

in response to the reception of the completion notice, notify the user that a registration of the printer is complete.

(((4)))

In the printer according to one of (((1))) through (((3))), the processor is configured to:

before transmitting to the cloud print server the replacement request used to replace the printer to be replaced with the printer, transmit to the printer to be replaced an abort instruction used to abort connection to the cloud print server.

(((5)))

In the printer according to one of (((1))) through (((4))), the processor is configured to:

receive from the cloud print server a completion notice indicating that replacing the printer to be replaced with the printer is complete; and

in response to the reception of the completion notice, notify the user that a registration of the printer to be replaced is deleted.

(((6)))

A printing system including: the printer according to one of (((1))) through (((5))), the printer to be replaced that is connected to the printer via the network, and the cloud print server.

(((7)))

A program causing a computer to execute a process including:

receiving a replacement instruction of printers used in a cloud print service;

in response to the reception of the replacement instruction, searching for, via a network, each of the printers used in the cloud print service as a candidate of a printer to be replaced;

receiving a designation of the printer to be replaced by presenting, to a user, identification information on the candidates of the printers to be replaced;

acquiring, via the network and from the printer to be replaced, printer-to-be-replaced connection information used to connect to a cloud print server; and

transmitting to the cloud print server a replacement request used to replace the printer to be replaced with the printer by connecting to the cloud print server via the network using the printer-to-be-replaced connection information.

What is claimed is:

1. A printer comprising:
a processor configured to:
receive a replacement instruction of printers used in a cloud print service;
in response to the reception of the replacement instruction, search for, via a network, each of the printers used in the cloud print service as a candidate of a printer to be replaced;
receive a designation of the printer to be replaced by presenting, to a user, identification information on the candidates of the printers to be replaced;
acquire, via the network and from the printer to be replaced, printer-to-be-replaced connection information used to connect to a cloud print server; and
transmit to the cloud print server a replacement request used to replace the printer to be replaced with the printer by connecting to the cloud print server via the network using the printer-to-be-replaced connection information.

2. The printer according to claim 1, wherein the processor is configured to:
present a selection screen that selectively receives the replacement instruction or an addition instruction of the printers used in the cloud print service; and
in response to the reception of the replacement instruction of the printers on the selection screen, perform a series of operations from searching for the candidates of the printers to be replaced to transmitting the replacement request.

3. The printer according to claim 1, wherein the processor is configured to:
receive from the cloud print server a completion notice indicating that replacing the printer to be replaced with the printer is complete; and
in response to the reception of the completion notice, notify the user that a registration of the printer is complete.

4. The printer according to claim 1, wherein the processor is configured to:
before transmitting to the cloud print server the replacement request used to replace the printer to be replaced with the printer, transmit to the printer to be replaced an abort instruction used to abort connection to the cloud print server.

5. The printer according to claim 1, wherein the processor is configured to:
receive from the cloud print server a completion notice indicating that replacing the printer to be replaced with the printer is complete; and
in response to the reception of the completion notice, notify the user that a registration of the printer to be replaced is deleted.

6. A printing system comprising: the printer according to claim 1, the printer to be replaced that is connected to the printer via the network, and the cloud print server.

7. A printing system comprising the printer according to claim 2, the printer to be replaced that is connected to the printer via the network, and the cloud print server.

8. A printing system comprising the printer according to claim 3, the printer to be replaced that is connected to the printer via the network, and the cloud print server.

9. A printing system comprising the printer according to claim 4, the printer to be replaced that is connected to the printer via the network, and the cloud print server.

10. A printing system comprising the printer according to claim 5, the printer to be replaced that is connected to the printer via the network, and the cloud print server.

11. A non-transitory computer readable medium storing a program causing a computer to execute a process comprising:
receiving a replacement instruction of printers used in a cloud print service;
in response to the reception of the replacement instruction, searching for, via a network, each of the printers used in the cloud print service as a candidate of a printer to be replaced;
receiving a designation of the printer to be replaced by presenting, to a user, identification information on the candidates of the printers to be replaced;
acquiring, via the network and from the printer to be replaced, printer-to-be-replaced connection information used to connect to a cloud print server; and
transmitting to the cloud print server a replacement request used to replace the printer to be replaced with the printer by connecting to the cloud print server via the network using the printer-to-be-replaced connection information.

12. A method comprising:
receiving a replacement instruction of printers used in a cloud print service;
in response to the reception of the replacement instruction, searching for, via a network, each of the printers used in the cloud print service as a candidate of a printer to be replaced;
receiving a designation of the printer to be replaced by presenting, to a user, identification information on the candidates of the printers to be replaced;
acquiring, via the network and from the printer to be replaced, printer-to-be-replaced connection information used to connect to a cloud print server; and
transmitting to the cloud print server a replacement request used to replace the printer to be replaced with the printer by connecting to the cloud print server via the network using the printer-to-be-replaced connection information.
